(19) United States
(12) Patent Application Publication
(10) Pub. No.: US 2006/0294028 A1
(43) Pub. Date: Dec. 28, 2006

(54) METHODOLOGY FOR DETERMINING THE VOLUME AND MARKET VALUE OF VOID SPACE PROPERTIES FOR THE PURPOSE OF A SALE, TRANSFER OR DONATION

(76) Inventor: J. Stuart Limb, Scottsdale, AZ (US)

Correspondence Address: WEISS & MOY PC, 4204 NORTH BROWN AVENUE, SCOTTSDALE, AZ, 85251, US

(21) Appl. No.: 11/426,275

(22) Filed: Jun. 23, 2006

Related U.S. Application Data
(60) Provisional application No. 60/693,166, filed on Jun. 23, 2005.

(51) Int. Cl. G06F 17/00

(52) U.S. Cl. 705/400

(57) ABSTRACT

A method for determining a volume and market value of void space properties comprises: determining a correct amount of void space to be utilized in an appraisal; performing a three-dimension volumetric calculation to determining the amount of void space to be appraised; determining reproduction cost for the void space; providing detailed information as to how various costs are allocated as part of the appraisal process; adjusting the reproduction cost derived market value by comparing the reproduction cost derived market value with other market comparables derived from actual sales of void space properties which have been sold based on the amount of void space in question; and adjusting the market comparables to match the void space property being appraised.

### RELATED APPLICATION

This application is related to U.S. Provisional Application Ser. No. 60/693,166, filed Jun. 23, 2005, in the name of the same inventors listed above, and entitled, “METHODOLOGY FOR DETERMINING THE VOLUME AND MARKET VALUE OF VOID SPACE PROPERTIES FOR THE PURPOSE OF A SALE, TRANFER OR DONATION TO FEDERAL, STATE, COUNTY, CITY AND OTHER PUBLIC AUTHORITIES AND AGENCIES”. The present patent application claims the benefit under 35 U.S.C. §119(e).

### FIELD OF THE INVENTION

The present invention relates generally to real estate, and more specifically, a methodology for determining the volume and market value of void space properties for the purpose of sale, transfer or donation.

### BACKGROUND OF THE INVENTION

Real estate appraisers typically use one or more different approaches in appraising real property. The typical approaches generally used are: (1) Market Approach, (2) Income Approach, and (3) Cost Approach. The market approach is based on the premise that the value of a specific property is set by the price an informed purchaser would pay for a comparable property, offering similar desirability and usefulness. In a market approach, sales of properties comparable (comparables) to the property being appraised (subject property) are identified. The value of the comparable(s) is then adjusted to allow for any differences between the comparable and the subject property. This will provide a value range for the subject property. A figure within that value range is then selected as the most defensible indication of the market value of the Subject Property.

The income approach to value is based on the premise that the value of a property is directly related to the income it will generate. The appraiser analyzes both the property's ability to produce future income and its expenses, and then estimates the property's value. The appraiser also develops a capitalization rate by analyzing the sales of similar income properties and determining the relationship between the sale price and net income.

The cost approach is used in the case of unique or unusual properties which are not commonly bought or sold in the market place. An example of such properties would be churches, oil refineries, pits, quarries, etc. The steps in applying the cost approach include: (1) estimating the site value (land and site improvements) through review of comparable sales; (2) estimating the cost of replacing the existing building with one of similar usefulness (reflecting current building design and materials); and (3) deducting all sources of depreciation, including physical deterioration (“wear and tear” on a building) and functional and economic obsolescence. Functional obsolescence is the reduced ability of the building to perform the function it was originally designed and built for. Economic obsolescence refers to external forces that affect the ability of the buildings to continue to perform, including changes in transportation corridors, new types of building design demanded by the market, etc.

In general, public authorities and agencies place the most reliance on the market approach. The income approach and the cost approach are considered to be too speculative unless supported by a market approach analysis. However, for certain properties, a market approach is not viable option. This is especially true for unique type properties such as pits and quarries.

Therefore, it would be desirable to provide a methodology for determining the volume and market value of void space properties for the purpose of sale, transfer or donation. The methodology for determining the volume and market value of void space properties must be more accurate then present methodologies of the prior art.

### SUMMARY OF THE INVENTION

In accordance with one embodiment of the present invention, a method for determining a volume and market value of void space properties is disclosed. The method comprises: determining a correct amount of void space to be utilized in an appraisal; performing a three-dimension volumetric calculation to determining the amount of void space to be appraised; determining reproduction cost for the void space; providing detailed information as to how various costs are allocated as part of the appraisal process; adjusting the reproduction cost derived market value by comparing the reproduction cost derived market value with other market comparables derived from actual sales of void space properties which have been sold based on the amount of void space in question; and adjusting the market comparables to match the void space property being appraised.

In accordance with another embodiment of the present invention, a method for determining a volume and market value of void space properties is disclosed. The method comprises: determining a correct amount of void space to be utilized in an appraisal; performing a three-dimension volumetric calculation to determining the amount of void space to be appraised, wherein performing a three-dimension volumetric calculation to determining the amount of void space to be appraised comprises: data compilation; data modeling; and reporting; analyze and present reproduction cost data to determining reproduction cost for the void space; provide detailed information as to how various costs are allocated as part of the appraisal process; adjusting the reproduction cost derived market value by comparing the reproduction cost derived market value with other market comparables derived from actual sales of void space properties which have been sold based on the amount of void space in question, wherein adjusting the reproduction cost derived market value comprises analyzing the sales price of market comparables and reducing to a common denominator to allow comparison to the void space being appraised; comparing the common denominator values derived from the market comparables to a reproduction cost value of the void space being appraised reduced to the same common denominator; and adjusting the market comparables to match the void space property being appraised.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is a flowchart describing the method of the present invention.

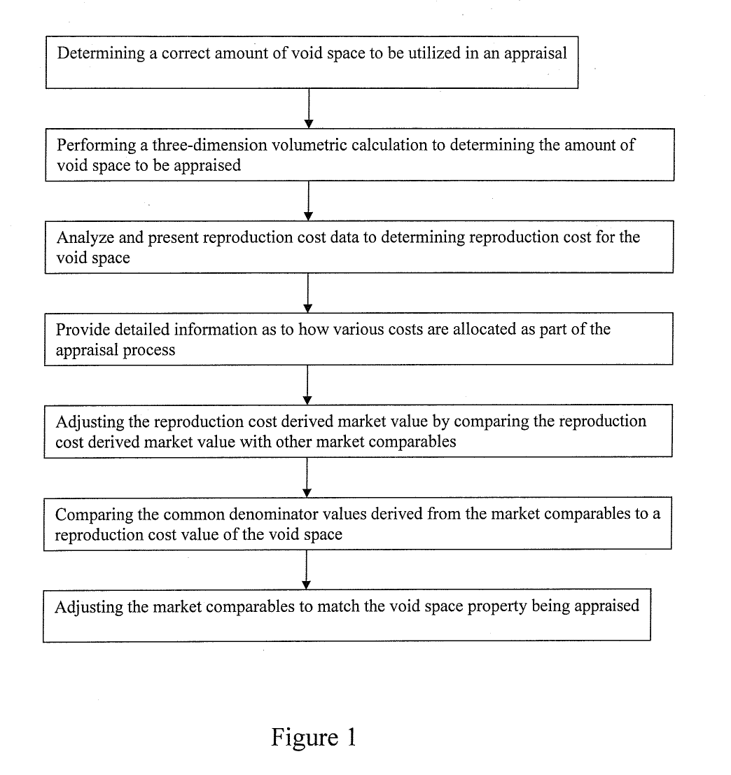

### DESCRIPTION OF PREFFERED EMBODIMENT

The present invention is a unique methodology for evaluating and appraising the market value of void space. The present methodology has been developed, tried and tested through actual transactions, meeting stringent appraisal standards mandated by public authorities/agencies contemplating real estate property acquisitions. The present methodology also meets the appraisal standards of the Internal Revenue Service (IRS) when evaluating charitable donations of real estate properties by entities claiming tax credits as a result of the transaction.

The present methodology provides a local qualified real estate appraiser with the information and methodology required to appraise a void space property, to standards acceptable to federal, state, county, city and other public authorities and agencies. The information and methodology, supplied to the local real estate appraiser, may be summarized as follows:

The methodology will take into account and advises the appraiser on the correct amount of void space to be utilized in the appraisal process. This is not always obvious. This includes determining whether more void space has to be created than is actually required. Additional void space may need to be considered due to the topography of the property, practical excavation considerations, geological conditions, excavation permit restrictions, economic considerations, access problems, safety considerations, environmental impacts and/or considerations, legal difficulties, requirements to support adjoining or adjacent properties, ground water conditions, engineering considerations, and the like.

An extremely precise, three dimensional (3-D) volumetric calculation is then utilized to determine the amount of void space to be appraised. The volumetric calculation is a three step process which includes data compilation, data modeling and reporting.

The data compilation is a multi-step process. Data compilation includes a review and evaluation of historical, regional and local geology/topography from published sources. A review and evaluation of current and historical mining processes/production from producers is also considered. Next, one will review and obtain copies of permits regarding reclamation, mining parameters, and regulatory requirements. A determination is then made to see if the remaining reserves exist, and the proposed method of disposal of these reserves (mined out, abandon, etc.). Accurate topographic data for the data model preparation is then acquired. In general, it is recommended that registered public land surveyors/engineers and methods be used to obtain accurate topographic data for the data model preparation. After completion of topographic survey(s), one will interface with the land surveyors/engineers to obtain the topographic survey(s) data in electronic formats. A determination of mining variances and regulations, such as mining losses, property and perimeter setbacks, slope and reclamation requirements are then made. Density conversion factors are then obtained of the mined material from laboratory analysis or published source.

After the data compilation stage, a data modeling stage is performed. The data modeling stage is a multi-step stage. In order to perform accurate data modeling, one needs to calibrate all computer software to the same coordinate systems, projections and scale as the compiled data. Then one needs to illustrate/digitize mining related perimeters on 2-dimensional and 3-dimensional topographic and aerial photograph base maps. Next, one will obtain/create 2-dimensional/3-dimensional digital topographic models from topographic, field, and published data. Constraints will be developed to bind the topographic model on all sides, top and bottom, based on the remaining reserves parameters and any imposed variances, regulations and/or reclamation requirements. Utilizing advanced geological, drafting and engineering software, one will filter and process the topographic model, utilizing the above referenced constraints, to form an accurate 3-D volumetric model of the remaining reserves. Constraints will be developed to bind the topographic model on all sides, top and bottom, based on any variances, regulations and/or reclamation requirements. An accurate 3-D volumetric model of the void space is formed utilizing advanced geological, drafting and engineering software to filter and process the topographic model, utilizing the above referenced constraints. Utilizing residual analyses, statistics and manual calculations are performed to check the accuracy of the volumetric models.

In the reporting stage, one needs to account for differences in calculated sale/lease/transfer/donation date and actual date. Three-dimensional plans are prepared illustrating topography, reserves, mining and mine plans, perimeters and void spaces. Three-dimensional plans are also prepared illustrating constraints utilized on topography for developing volumetric models. One then needs to convert the remaining reserves into cubic yards and tons (as per density conversion factors). When converting the remaining reserves into cubic yards and tons, one needs to account for mining losses and other parameters. The void space is then converted into cubic yards and cubic feet. Next, one needs to convert the void space into applicable storage dimensions (such as acre-feet). A technical memorandum is then prepared summarizing all of the above.

After the data compilation, data modeling, and reporting is completed, one needs to analyze and present reproduction cost data to allow for the reproduction cost of the void space to be determined, without the need for discounting. Next, one needs to provide detailed information as to how various costs are allocated as part of the appraisal process. This includes: (1) stockpiling cost allocation on excavated material; (2) disposal cost allocation on excavated material; (3) selling, general and administrative (SG & A) cost allocation; (4) excavation permitting cost allocation; and (5) entrepreneurial profit cost allocation.

Through a matrix of information derived from actual sales of void space properties (comparables) which have been sold based on the amount of void space in question, the local real estate appraiser is able to support the reproduction cost derived market value by comparing this market value with other market comparables, and adjusting accordingly.

Adjustments are made by analyzing the comparables' sale price and reducing them to a common denominator to allow comparison to the void space property being appraised. The common denominator is typically an acre-foot basis, in the case of the void space being used for water storage purposes, or a cubic yard basis where the void space is to be used for solid-fill purposes etc.

The range of common denominator values derived from the comparables may then be compared to the reproduction cost value of the void space being appraised, and reduced to the same common denominator (i.e., dollar per acre foot, dollar per cubic yard, and the like).

In a similar fashion to which real estate appraisers adjust their real estate comparables to match the property being appraised, the void space comparables may now be adjusted to match the void space property being appraised. These adjustments may include, but are not limited to include: (1) size and location of the comparables; (2) elevation, topography and geological comparisons of the comparables; and (3) extraction cost, permitting cost, access, environmental, economic, ground water, engineering end legal comparisons between the comparables and the void space property being appraised.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method for determining a volume and market value of void space properties comprising:
determining a correct amount of void space to be utilized in an appraisal;
performing a three-dimension volumetric calculation to determining the amount of void space to be appraised;
determining reproduction cost for the void space;
providing detailed information as to how various costs are allocated as part of the appraisal process;
adjusting the reproduction cost derived market value by comparing the reproduction cost derived market value with other market comparables derived from actual sales of void space properties which have been sold based on the amount of void space in question; and
adjusting the market comparables to match the void space property being appraised.

2. A method for determining a volume and market value of void space properties in accordance with claim 1 wherein determining a correct amount of void space to be utilized in an appraisal further comprises determining whether more void space has to be created than is actually required.

3. A method for determining a volume and market value of void space properties in accordance with claim 1 wherein performing a three-dimension volumetric calculation to determining the amount of void space to be appraised comprises:
data compilation;
data modeling; and
reporting.

4. A method for determining a volume and market value of void space properties in accordance with claim 3 wherein data compilation comprises:
review and evaluation of historical, regional and local geology/topography from published sources;
review and evaluation of current and historical mining processes/production from producers;
review and obtain copies of permits regarding reclamation, mining parameters, and regulatory requirements;
determining if remaining reserves exist and a proposed method of disposal of remaining reserves;
obtaining accurate topographic data for the data model preparation;
obtaining the topographic data in electronic formats;
determining mining variances and regulations; and
obtaining density conversion factors of mined material from one of laboratory analysis or published source.

5. A method for determining a volume and market value of void space properties in accordance with claim 4 wherein determining mining variances and regulations comprises determining mining losses, property and perimeter setbacks, slope and reclamation requirements.

6. A method for determining a volume and market value of void space properties in accordance with claim 3 wherein data modeling comprises:
calibrate all computer software to same coordinate systems, projections and scale as compiled data;
illustrate/digitize mining related perimeters on 2-dimensional and 3-dimensional topographic and aerial photograph base maps;
obtain/create 2-dimensional/3-dimensional digital topographic models from topographic, field, and published data;
develop constraints to bind the topographic model on all sides, top and bottom, based on the remaining reserves parameters and any imposed variances, regulations and/or reclamation requirements;
filter and process the topographic model utilizing the above referenced constraints to form an accurate 3-D volumetric model of remaining reserves;
develop constraints to bind the topographic model on all sides, top and bottom, based on any variances, regulations and/or reclamation requirements.
forming an accurate 3-D volumetric model of the void space;
checking the accuracy of the volumetric models.

7. A method for determining a volume and market value of void space properties in accordance with claim 6 wherein checking the accuracy of the volumetric models comprises utilizing residual analyses, statistics and manual calculations for checking the accuracy of the volumetric models.

8. A method for determining a volume and market value of void space properties in accordance with claim 3 wherein reporting comprises:
account for differences in calculated sale/lease/transfer/donation date and actual date;
prepare three-dimensional plans illustrating topography, reserves, mining and mine plans, perimeters and void spaces;
prepare three-dimensional plans illustrating constraints utilized on topography for developing volumetric models;
convert remaining reserves into cubic yards and tons accounting for mining losses and other parameters;
convert void space into cubic yards and cubic feet; and
convert void space into applicable storage dimensions.

9. A method for determining a volume and market value of void space properties in accordance with claim 3 wherein reporting further comprises prepare technical memorandum summarizing data.

10. A method for determining a volume and market value of void space properties in accordance with claim 1 wherein adjusting the reproduction cost derived market value comprises analyzing the sales price of market comparables and reducing to a common denominator to allow comparison to the void space being appraised.

11. A method for determining a volume and market value of void space properties in accordance with claim 10 wherein the common denominator is an acre-foot basis when the void space is being used for water storage purposes.

12. A method for determining a volume and market value of void space properties in accordance with claim 10 wherein the common denominator is a cubic yard basis where the void space is to be used for solid-fill purposes.

13. A method for determining a volume and market value of void space properties in accordance with claim 10 further comprising comparing the common denominator values derived from the market comparables to a reproduction cost value of the void space being appraised reduced to the same common denominator.

14. A method for determining a volume and market value of void space properties in accordance with claim 1 wherein adjusting the market comparables to match the void space property being appraised comprises adjusting for size and location of the market comparables between the market comparables and the void space property being appraised.

15. A method for determining a volume and market value of void space properties in accordance with claim 14 wherein adjusting the market comparables to match the void space property being appraised further comprises adjusting for elevation, topography and geological comparisons of the market comparables and the void space property being appraised.

16. A method for determining a volume and market value of void space properties in accordance with claim 14 wherein adjusting the market comparables to match the void space property being appraised further comprises adjusting for extraction cost, permitting cost, access, environmental, economic, ground water, engineering end legal comparisons between the market comparables and the void space property being appraised.

17. A method for determining a volume and market value of void space properties comprising:
determining a correct amount of void space to be utilized in an appraisal;
performing a three-dimension volumetric calculation to determining the amount of void space to be appraised, wherein performing a three-dimension volumetric calculation to determining the amount of void space to be appraised comprises:
data compilation;
data modeling; and
reporting;
analyze and present reproduction cost data to determining reproduction cost for the void space;
provide detailed information as to how various costs are allocated as part of the appraisal process;
adjusting the reproduction cost derived market value by comparing the reproduction cost derived market value with other market comparables derived from actual sales of void space properties which have been sold based on the amount of void space in question, wherein adjusting the reproduction cost derived market value comprises analyzing the sales price of market comparables and reducing to a common denominator to allow comparison to the void space being appraised;
comparing the common denominator values derived from the market comparables to a reproduction cost value of the void space being appraised reduced to the same common denominator; and
adjusting the market comparables to match the void space property being appraised.

18. A method for determining a volume and market value of void space properties in accordance with claim 17 wherein determining a correct amount of void space to be utilized in an appraisal further comprises determining whether more void space has to be created than is actually required.

19. A method for determining a volume and market value of void space properties in accordance with claim 17 wherein data compilation comprises:
review and evaluation of historical, regional and local geology/topography from published sources;
review and evaluation of current and historical mining processes/production from producers;
review and obtain copies of permits regarding reclamation, mining parameters, and regulatory requirements;
determining if remaining reserves exist and a proposed method of disposal of remaining reserves;
obtaining accurate topographic data for the data model preparation;
obtaining the topographic data in electronic formats;
determining mining variances and regulations; and
obtaining density conversion factors of mined material from one of laboratory analysis or published source.

20. A method for determining a volume and market value of void space properties in accordance with claim 21 wherein determining mining variances and regulations comprises determining mining losses, property and perimeter setbacks, slope and reclamation requirements.

22. A method for determining a volume and market value of void space properties in accordance with claim 17 wherein data modeling comprises:
calibrate all computer software to same coordinate systems, projections and scale as compiled data;
illustrate/digitize mining related perimeters on 2-dimensional and 3-dimensional topographic and aerial photograph base maps;
obtain/create 2-dimensional/3-dimensional digital topographic models from topographic, field, and published data;
develop constraints to bind the topographic model on all sides, top and bottom, based on the remaining reserves parameters and any imposed variances, regulations and/or reclamation requirements;
filter and process the topographic model utilizing the above referenced constraints to form an accurate 3-D volumetric model of remaining reserves;
develop constraints to bind the topographic model on all sides, top and bottom, based on any variances, regulations and/or reclamation requirements.
forming an accurate 3-D volumetric model of the void space;
checking the accuracy of the volumetric models.

23. A method for determining a volume and market value of void space properties in accordance with claim 22 wherein checking the accuracy of the volumetric models comprises utilizing residual analyses, statistics and manual calculations for checking the accuracy of the volumetric models.

24. A method for determining a volume and market value of void space properties in accordance with claim 17 wherein reporting comprises:
account for differences in calculated sale/lease/transfer/donation date and actual date;
prepare three-dimensional plans illustrating topography, reserves, mining and mine plans, perimeters and void spaces;
prepare three-dimensional plans illustrating constraints utilized on topography for developing volumetric models;
convert remaining reserves into cubic yards and tons accounting for mining losses and other parameters;
convert void space into cubic yards and cubic feet; and
convert void space into applicable storage dimensions.

25. A method for determining a volume and market value of void space properties in accordance with claim 24 wherein reporting further comprises prepare technical memorandum summarizing data.

26. A method for determining a volume and market value of void space properties in accordance with claim 17 wherein the common denominator is an acre-foot basis when the void space is being used for water storage purposes.

27. A method for determining a volume and market value of void space properties in accordance with claim 17 wherein the common denominator is a cubic yard basis where the void space is to be used for solid-fill purposes.

28. A method for determining a volume and market value of void space properties in accordance with claim 17 wherein adjusting the market comparables to match the void space property being appraised comprises adjusting for size and location of the market comparables between the market comparables and the void space property being appraised.

29. A method for determining a volume and market value of void space properties in accordance with claim 28 wherein adjusting the market comparables to match the void space property being appraised further comprises adjusting for elevation, topography and geological comparisons of the market comparables and the void space property being appraised.

30. A method for determining a volume and market value of void space properties in accordance with claim 29 wherein adjusting the market comparables to match the void space property being appraised further comprises adjusting for extraction cost, permitting cost, access, environmental, economic, ground water, engineering end legal comparisons between the market comparables and the void space property being appraised.

31. A method for determining a volume and market value of void space properties comprising in accordance with claim 17 wherein providing detailed information as to how various costs are allocated as part of the appraisal process further comprises providing detailed information as to stockpiling cost allocation on excavated material; disposal cost allocation on excavated material; selling, general and administrative cost allocation; excavation permitting cost allocation; and entrepreneurial profit cost allocation.
